(19) United States
(12) Patent Application Publication
(10) Pub. No.: US 2014/0279137 A1
(43) Pub. Date: Sep. 18, 2014

(54) METHODS, SYSTEMS, AND APPARATUS FOR DYNAMIC BID RESOLUTION

(71) Applicant: Roy Leon Camp, Fresno, CA (US)

(72) Inventor: Roy Leon Camp, Fresno, CA (US)

(73) Assignee: eBay Inc., San Jose, CA (US)

(21) Appl. No.: 13/839,742

(22) Filed: Mar. 15, 2013

(51) Int. Cl. G06Q 30/08

(52) U.S. Cl. CPC G06Q 30/08
USPC 705/26.3

(57) ABSTRACT

Methods, systems, and apparatus to resolve offers to provide an item to a consumer are described. An item may be one or more of a product and a service. A request for an item may be provided to one or more providers of the product and/or service. One or more bids to provide an offer for the requested item may be received and the received bids may be compared. The one or more providers may be informed of the one or more most competitive bids, and may provide revised bids until the bidding period ends. A consumer may be informed of the one or more most competitive offers.

### TECHNICAL FIELD

The present application relates generally to commerce automation, and more specifically, in one example, to resolving bids to offer a product or service to a consumer.

### BACKGROUND

Consumers often shop online for a wide variety of products and services and may request information, such as pricing information, for the product or service. Consumers of products and services may generally include retail consumers, distributors, small business owners, business representatives, corporate representatives, non-profit organizations, and any other consumer of a product and/or service. The providers of the products and services may bid to provide the product and/or service to the consumer. The providers may include retailers, wholesalers, distributors, manufacturers, service providers, and the like. The bid may comprise a price and, optionally, one or more specific terms for the offer.

Some websites offer a service of compiling competitive offers from a plurality of providers and presenting the offers to a consumer. The consumer, or user, may then select the offer or offers that have the most desirable price and terms. The providers whose offers are not presented and/or not selected by the consumer may have no further opportunity to submit a revised bid. Moreover, the bidder with the lowest price may have submitted a bid with a substantially lower price than was necessary to attain the lowest price bid of all the competing providers.

### BRIEF DESCRIPTION OF THE DRAWINGS

Some embodiments are illustrated by way of example and not limitation in the figures of the accompanying drawings in which:

FIG. 1 is a block diagram of an example system, in accordance with an example embodiment, for resolving bids to offer a product and/or service to a consumer;

FIG. 2 is an example representation of a sorted item listing;

FIG. 3 is an example representation of a rule base comprising one or more rules that may be statically or dynamically used to determine one or more bids to offer a product or service, in accordance with an example embodiment;

FIG. 4 is an example representation of a bid status data element comprising one or more bids from one or more providers of a product and/or service, in accordance with an example embodiment;

FIG. 5 is a block diagram of an example apparatus, in accordance with an example embodiment, for resolving bids to offer a product and/or service to a consumer;

FIG. 6 is an example flowchart for a bid resolution method, in accordance with an example embodiment;

FIG. 7 is a block diagram of an example apparatus, in accordance with an example embodiment, for providing bids to offer a product and/or service to a consumer;

FIG. 8 is an example flowchart for an offer bidding method, in accordance with an example embodiment;

FIG. 9 is an example representation of a user interface for initiating a request for information, including pricing information, for a product and/or service, in accordance with an example embodiment;

FIG. 10 is an example flowchart for a consumer user interface method for obtaining offers for a product and/or service, in accordance with an example embodiment; and

FIG. 11 is a block diagram of machine within which instructions may be executed for causing the machine to perform any one or more of the methodologies discussed herein.

### DETAILED DESCRIPTION

In the following detailed description of example embodiments, reference is made to specific examples by way of drawings and illustrations. These examples are described in sufficient detail to enable those skilled in the art to practice these example embodiments, and serve to illustrate how the invention may be applied to various purposes or embodiments. Other embodiments of the invention exist and are within the scope of the invention, and logical, mechanical, electrical, and other changes may be made without departing from the scope or extent of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

Generally, methods, systems, and apparatus for resolving bids to offer a product and/or service to a consumer are described. In one example embodiment, a consumer may indicate an interest in obtaining pricing and/or other information for an item. As used herein, an “item” may refer to a product and/or service. The interest may be indicated by a search for the item, a request for information for the item, a request for pricing information for the item, a selection of an item from a listing, and the like. The interest may be communicated directly to a number of providers of the item as a request for offers, or may be communicated to an intermediary that may communicate the interest to a number of providers. The providers may respond by submitting one or more bids to offer the item to the consumer. The bids may be submitted to an intermediary and the intermediary may resolve the bids to determine the one or more most competitive offers. In one example embodiment, the one or more most competitive offers may be the lowest price offer(s). The one or more most competitive offers may be presented to the interested consumer. In one example embodiment, the intermediary may be a bid resolution apparatus. In one example embodiment, the intermediary may be a bid resolution service, and the bid resolution service may utilize a bid resolution apparatus.

In one example embodiment, a provider may submit a rule base to a bid resolver. The bid resolver may utilize the rule base to generate one or more bids on behalf of the provider.

FIG. 1 is a block diagram of an example system 100, in accordance with an example embodiment, for resolving bids to offer a product and/or service to a consumer. In one example embodiment, the system 100 may comprise one or more user devices 104-1, 104-2 and 104-N, one or more offer processing systems 108-1, 108-2 and 108-N (known as offer processing systems 108 hereinafter), a bid resolution processing system 110, an optional bid repository 120, a network 115, and an optional item identification processing system 130. Each user device (e.g., 104-1) may be a personal computer (PC), a cellular phone, a personal digital assistant (PDA), or any other appropriate computer device. Each user device (104-1, 104-2 or 104-N) may include an item listing request engine (not shown). In one embodiment, the item listing request engine may comprise a web browser program. Although a detail description is only illustrated for user device 104-1, it is noted that each of the other user devices (e.g., user device 104-2 through user device 104-N) may have corresponding elements with the same functionality.

The offer processing system(s) 108 and the bid resolution processing system 110 may be a server, client, or other processing device that includes an operating system for executing software instructions. The optional bid repository 120 may be a table, array, linked list, index, database, and/or other data structure. The optional bid repository 120 may store a bid status data element 400, described more fully below in conjunction with FIG. 4.

The network 115 may be a local area network (LAN), a wireless network, a metropolitan area network (MAN), a wide area network (WAN), a wireless network, a network of interconnected networks, the public switched telephone network (PSTN), and the like.

The item listing request engine may receive a query for item information from a user via an input device such as keyboard, mouse, electronic pen, etc. (not shown in FIG. 1). An item may comprise a product and/or a service and the corresponding information may be in the form of an item listing.

An item identification processing system 130 of an online listing system may store and/or obtain many item listings. Each item listing may comprise a detailed description for an item. The item associated with an item listing may be a good or product (e.g., a tablet computer) or service (e.g., a round of golf) that may be transacted (e.g., exchanging, sharing information about, buying, selling, making a bid on, and the like). The item listing may include a title, a category (e.g., electronics, sporting goods, books, antiques, and the like), and other tag information (e.g., color, size, and the like).

Referring back to the user device 104-1, the query received from the user of user device 104-1 may comprise one or more keywords. The item listing request engine may then transmit the query to the item identification processing system 130 via the network 115. The item identification processing system 130 may attempt to match the query keywords with the title, the category, the tag information, or any other field in the item listing using a search engine.

In response to the submission of the search query, the search engine may attempt to identify one or more item listings that satisfy the query. The search engine may retrieve and then sort the item listings in the search result in a known manner. The item identification processing system 130 may then return a sorted search result via the item listing request engine to the user device 104-1 that submitted the query.

In one example embodiment, a bid resolution service may accept one or more bids from one or more providers, may resolve the one or more bids to determine the most competitive bid(s), or offer(s), and may present the one or more most competitive offers to the interested consumer. In one example embodiment, a provider of the bid resolution service may receive compensation from one or more of the providers. The compensation may be in the form of a payment per bid, a payment per offer presented to a consumer, a payment per transaction, a subscription fee, an advertising fee, and the like.

In one example embodiment, a rule base may comprise one or more rules that may be statically or dynamically used to generate one or more bids to offer a product or service. Static bid resolution may comprise determining a bid prior to receiving a request for the product and/or service. Dynamic bid resolution may comprise determining a bid after receiving a request for the product and/or service.

Each rule may comprise a condition for applying the rule and a corresponding action to be executed when the condition is met. Example conditions may comprise: 1) a location of a consumer; 2) a level of inventory of a product; 3) a backlog of a service; 4) an identity of a competing bidder; 5) a price of a pending lowest bid; 6) a proximity of a competitor to a consumer; 7) an on-line price; 8) a provider's present bid; and the like. Example actions may comprise: 1) submitting a bid based on an initial offer price; 2) submitting a bid with a minimum offer price; 3) submitting a bid based on a formula for incrementally determining a new offer price; 4) submitting a bid based on an amount by which to reduce the price below a competing bid; 5) submitting a bid based on an amount by which to reduce the price below a competing bid of one or more specified competitors; 6) submitting a bid with additional terms or incentives (e.g. coupons) to be included in an offer; 7) submitting a bid based on a consumer's location (e.g. offer prices based on the location of the consumer, offer prices based on a proximity of a consumer to a brick and mortar store, and the like); 8) submitting a bid based on a formula for determining a new offer price based on an identity of and/or count of competing bidders; 9) submitting a bid based on a formula for determining a new offer price based on an identity of a consumer; 10) submitting a bid based on a formula for determining a new offer price based on an inventory status; and the like.

In one example embodiment, an action associated with a rule may comprise a request or requirement that an offer is to be presented as an exclusive listing. An exclusive listing, as used herein, is a listing that is presented as the only offer available to a consumer. In one example embodiment, an offer may only be presented as an exclusive listing if the offer is the most competitive offer at the end of the bidding period. A provider may be charged a fee for obtaining an exclusive listing.

In one example, a coupon for an in-store and/or online discount may be provided as a component (or term) of an offer in order to, for example, generate in-store and/or online consumer traffic. In another example, if a consumer requests pricing information while located in the store of a first retailer, a rule in the rule base of a second retailer may indicate that a bid is to be submitted with a price smaller than the last known price of the first retailer.

FIG. 2 is an example representation of a sorted item listing 200, according to an embodiment. Each row 202 of sorted item listing 200 may correspond to an item. Column 204 may comprise an item identifier, column 208 may comprise an item name, and column 212 may comprise an item description.

The user (consumer) may be presented with an interface that includes the items from the sorted item listing 200 and select one or more items. The item selection(s) may be received by the bid resolution processing system 110. The bid resolution processing system 110 may forward the item selection(s) to providers that indicated a capacity to provide the requested product and/or service.

In one example embodiment, in response to receiving a list of the selected item(s), the offer processing system(s) 108 may provide to the bid resolution processing system 110 one or more offers to provide the corresponding product and/or service. In one example embodiment, the offer processing system(s) 108 may provide a rule base to the bid resolution processing system 110 to enable the bid resolution processing system 110 to generate and process bids on behalf of the corresponding offer processing system 108.

In one example embodiment, the bid resolution processing system 110 may compare each received bid and may return the price of the lowest bid to each of the offer processing systems 108. The offer processing systems 108 may review the lowest bid and may respond with a revised bid, or may withdraw from bidding and may become a non-participating bidder. Each time the bid resolution processing system 110 receives a bid with a new lowest price, the bid resolution processing system 110 informs the participating offer processing systems 108 of the new lowest price. As described above, the bid resolution processing system 110 may generate and process bids on behalf of one or more providers in accordance with a provided rule base.

The bid resolution processing system 110 may continue processing bids until the bidding period ends. The bidding period may end: 1) at a predefined time; 2) when no new bids have been received for a predefined time period; and/or 3) when only one provider remains as a participating provider.

FIG. 3 is an example representation of a rule base 300 comprising one or more rules that may be statically or dynamically used to determine one or more bids to offer a product or service, in accordance with an example embodiment. Each row 302 of the rule base may correspond to one rule. Column 304 may comprise a rule identifier, column 308 may comprise the condition for applying the corresponding rule, column 312 may comprise a bid price or formula for calculating the bid price for the product and/or service, and column 316 may comprise one or more optional terms for the bid. Example conditions may include one or more of: 1) a location of a consumer; 2) a level of inventory of a product; 3) a backlog of a service; 4) an identity of a competing bidder; and the like. Example formulas may include: 1) a percentage to reduce the provider's present bid; 2) a percentage to reduce the lowest pending bid; 3) an amount to reduce the provider's present bid; 4) an amount to reduce the lowest pending bid; 5) a minimum bid price; and the like. Example terms may include one or more of: 1) a time period for the offer; 2) a coupon for one or more additional discounts; 3) a delivery charge; and the like.

FIG. 4 is an example representation of a bid status data element 400 comprising one or more bids from one or more providers of a product and/or service, in accordance with an example embodiment. A bid status data element 400 may be maintained for each product and/or service for which bid resolution is being performed. Each row 402 of the bid status data element 400 may correspond to a bid from a corresponding provider. Each provider may submit more than one bid. For example, a provider may submit two bids, each bid comprising different terms. Column 404 may comprise a bid identifier, column 408 may comprise an identifier of a provider, column 412 may comprise a bid status, column 416 may comprise a bid price, and column 420 may comprise one or more optional terms for the bid.

Examples of bid status may include one or more of: 1) pending; 2) rejected; 3) withdrawn; 4) active; 5) accepted; and 6) lowest. A pending bid may be a bid that is pending during bid resolution. A rejected bid may be a bid that is rejected by a consumer or by the bid resolution process. A withdrawn bid may be a bid withdrawn by a provider. An active bid may be a bid presented to a consumer. An accepted bid may be a bid accepted by a consumer. A lowest bid may be a pending bid that is a lowest priced bid during the bid resolution process.

FIG. 5 is a block diagram of an example apparatus 500, in accordance with an example embodiment, for the bid resolution processing system 110 for resolving bids to offer a product or service to a consumer.

The apparatus 500 is shown to include a processing system 502 that may be implemented on a client or other processing device that includes an operating system 504 for executing software instructions. In accordance with an example embodiment, the apparatus 500 may include a bid receiving module 506, a bid resolution module 510, a bid reporting module 514, and a user interface module 518. In accordance with an example embodiment, the apparatus 500 may further include a storage interface 522, a rule base data structure 526 and a bid status data structure 530. For example, a rule base data structure 526 may contain one or more rules that may be statically or dynamically used to generate one or more offers for a product or service.

The bid receiving module 506 may receive one or more bids and/or a rule base from one or more offer processing systems 108. The bid resolution module 510 may accept one or more bids from one or more providers and may resolve the one or more bids to determine the one or more most competitive offers. The bid resolution module 510 may generate and process a bid on behalf of a provider(s). The bid reporting module 514 may report the lowest price pending bid and/or the end of the bidding period to a provider. The user interface module 518 may present one or more of the most competitive offers to a consumer.

FIG. 6 is an example flowchart for a bid resolution method 600, in accordance with an example embodiment. In one example embodiment, a request associated with a product and/or service may be received (operation 604) and may be submitted to one or more providers of the product and/or service (operation 608). One or more bids to provide an offer may be obtained from one or more of the participating providers (operation 612). One or more bids may optionally be generated on behalf of one or more providers according to one or more rule bases (operation 616). The pending bids may be compared and one or more lowest price bids may be determined (operation 620). The participating providers may be informed of the one or more most competitive bids (operation 624). In one example embodiment, the most competitive bid is a lowest price bid. A test may be performed to determine if there is more than one participating provider (operation 628). If there is only one participating provider, the method may proceed to operation 630. If there is more than one participating provider, the method may proceed to operation 612.

During operation 630, the consumer may be informed of the one or more most competitive offers and optional terms, and the provider may be informed that the bidding period has ended. The consumer may select one or more of the presented offers in a known manner.

FIG. 7 is a block diagram of an example apparatus 700, in accordance with an example embodiment, for the offer processing system 108 for providing bids to offer a product and/or service to a consumer.

The apparatus 700 is shown to include a processing system 702 that may be implemented on a client or other processing device that includes an operating system 704 for executing software instructions. In accordance with an example embodiment, the apparatus 700 may include a bid request and status receiving module 706, a bid generator module 710, and an offer status module 714. In accordance with an example embodiment, the apparatus 700 may include storage interface 722 and a rule base data structure 730. For example, a rule base data structure 730 may contain one or more rules that may be statically or dynamically used to generate one or more offers for a product and/or service.

The bid request and status receiving module 706 may receive one or more requests for offers and/or a bid status from the bid resolution processing system 110. The bid generator module 710 may generate one or more bids to offer a product and/or service. The offer status module 714 may track the status of one or more submitted bids (offers).

FIG. 8 is an example flowchart for an offer bidding method 800, in accordance with an example embodiment. In one example embodiment, a request to bid on an offer to provide a product and/or service may be received (operation 804). One or more bids may be generated by executing a bid generator (operation 808). One or more of the bids may be generated according to one or more rule bases.

A test may be performed to determine if at least one bid was generated (operation 812). If no bid was generated, then a message is returned indicating that the provider is withdrawing from bidding (operation 816) and the method ends. If at least one bid was generated, then a message comprising the one or more bids (offers) is returned (operation 820). A test is performed to determine if a response message to the bid was received (operation 824). If a response message was received indicating that the offer was one of the selected lowest price offers and indicating the bidding period has ended, the bid (offer) is marked as an active offer (operation 828) and the method ends. If a response message was received indicating that the offer was not one of the selected lowest price offers and indicating the bidding period has ended, the bid (offer) is marked as rejected offer (operation 832) and the method ends. If a response message was received comprising an updated price of the lowest pending bid, the method proceeds to operation 808.

FIG. 9 is an example representation of a user interface 900 for initiating a request for information, including pricing information, for a product and/or service, in accordance with an example embodiment. A mobile device may provide the user interface 900, for example. In one example embodiment, a user may search for a product and/or service by entering one or more keywords via the input field 902. A list of products and/or services may be presented in an item listing field 904. The consumer may select one or more items from the item listing field 904 to request an offer for the selected product and/or service. The selected item may be submitted to the bid resolution processing system 110 and the bid resolution processing system 110 may respond by providing one or more most competitive offers. The one or more most competitive offers for the product and/or service may be displayed in an offer listing field 908. The consumer may select one or more of the presented offers in a known manner.

FIG. 10 is an example flowchart for a consumer user interface method 1000 for obtaining offers for a product and/or service, in accordance with an example embodiment. In one example embodiment, a user may enter one or more keywords related to a product and/or service (operation 1004). As noted above, the item listing request engine may then transmit the query to the item identification processing system 130 via the network 115 (operation 1008). In response to the search query, the item identification processing system 130 may attempt to identify one or more item listings that satisfy the query. The item identification processing system 130 may retrieve and then sort the search results to produce the item listings in a known manner. The item identification processing system 130 may then return a sorted item listing 200 via the item listing request engine to the user device 104-1 that sent the query. The user device 104-1 may display the sorted item listing 200 in the item listing field 904 (operation 1012). A consumer may select one or more items from the sorted item listing 200 (operation 1016) and the item selection(s) may be sent to the bid resolution processing system 110 (operation 1020). The bid resolution processing system 110 may forward the item selections to providers that indicated a capacity to provide the requested product and/or service. The bid resolution processing system 110 may send the one or more most competitive offers to the user device 104-1.

A test may be performed to determine if one or more offers have been received (operation 1024). If one or more offers have been received, the user device 104-1 may display the offer(s) in the offer listing field 908 (operation 1028). If no offers have been received, the user device 104-1 may display a message indicating that no offers have been received in the offer listing field 908 (operation 1032).

Although certain examples are shown and described here, other variations exist and are within the scope of the invention. It will be appreciated by those of ordinary skill in the art that any arrangement, which is designed or arranged to achieve the same purpose, may be substituted for the specific embodiments shown. This application is intended to cover any adaptations or variations of the example embodiments of the invention described herein. It is intended that this invention be limited only by the claims, and the full scope of equivalents thereof.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses) that connects the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

FIG. 11 is a block diagram of a machine within which instructions may be executed for causing the machine to perform any one or more of the methodologies discussed herein. In one example embodiment, the machine may be the user device 104. In one example embodiment, the machine may be the bid resolution processing system 110 and/or the offer processing system 108. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a central processing unit (CPU), a graphics processing unit (GPU) or both), a main memory 1104 and a static memory 1106, which communicate with each other via a bus 1108. The computer system 1100 may further include a video display unit 1110 (e.g., a liquid crystal display (LCD) or a cathode ray tube (CRT)). The computer system 1100 also includes an alphanumeric input device 1112 (e.g., a keyboard), a user interface (UI) navigation device 1114 (e.g., a mouse), a disk drive unit 1116, a signal generation device 1118 (e.g., a speaker) and a network interface device 1120.

### Machine-Readable Medium

The drive unit 1116 includes a machine-readable medium 1122 on which is stored one or more sets of instructions and data structures (e.g., software) 1124 embodying or utilized by any one or more of the methodologies or functions described herein. The instructions 1124 may also reside, completely or at least partially, within the main memory 1104 and/or within the processor 1102 during execution thereof by the computer system 1100, the main memory 1104 and the processor 1102 also constituting machine-readable media. Instructions may also reside within the static memory 1106.

While the machine-readable medium 1122 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1124 may further be transmitted or received over a communications network 1126 using a transmission medium. The instructions 1124 may be transmitted using the network interface device 1120 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. An apparatus to resolve bids to offer an item, the apparatus comprising:
a processor;
memory to store instructions that, when executed by the processor cause the processor to:
provide a request for the item to one or more providers, the item is one or more of a product and a service;
receive one or more bids to provide an offer for the requested item;
compare the received bids;
inform the one or more providers of the one or more most competitive bids; and
repeat the receive, compare, and inform operations until a bidding period ends.

2. The apparatus of claim 1, wherein the bidding period ends when only one bid is received during a predefined period.

3. The apparatus of claim 1, wherein the bidding period ends after a predefined period of time.

4. The apparatus of claim 1, wherein the bidding period ends when only one participating provider remains.

5. The apparatus of claim 1, wherein the instructions, when executed by the processor, further cause the processor to inform a user of the one or more most competitive offers.

6. The apparatus of claim 1, wherein the most competitive offer is a lowest price offer.

7. The apparatus of claim 1, wherein the instructions, when executed by the processor, further cause the processor to obtain one or more rule bases from one or more of the one or more providers.

8. The apparatus of claim 7, wherein the instructions, when executed by the processor, further cause the processor to generate a bid based on one of the rule bases.

9. The apparatus of claim 7, wherein a rule comprises one or more conditions and one or more price formulas.

10. The apparatus of claim 9, wherein the rule comprises one or more terms.

11. The apparatus of claim 8, wherein the bid is generated before a request is received.

12. The apparatus of claim 8, wherein the bid is generated after a request is received.

13. A method for resolving bids to offer an item, the method comprising:
providing a request for the item to one or more providers, the item is one or more of a product and a service;
receiving one or more bids to provide an offer for the requested item;
comparing the received bids;
informing the one or more providers of the one or more most competitive bids; and
repeating the receive, compare, and inform operations until a bidding period ends.

14. The method of claim 13, wherein the bidding period ends when only one bid is received during a predefined period.

15. The method of claim 13, wherein the bidding period ends after a predefined period of time.

16. The method of claim 13, wherein the bidding period ends when only one participating provider remains.

17. The method of claim 13, further comprising informing a user of the one or more most competitive offers.

18. The method of claim 13, wherein the most competitive offer is a lowest price offer.

19. The method of claim 13, further comprising obtaining one or more rule bases from one or more of the one or more providers.

20. The method of claim 18, further comprising generating a bid based on one of the rule bases.

21. The method of claim 18, wherein a rule comprises one or more conditions and one or more price formulas.

22. The method of claim 21, wherein the rule comprises one or more terms.

23. The method of claim 20, wherein the bid is generated before a request is received.

24. The method of claim 20, wherein the bid is generated after a request is received.

25. A non-transitory computer-readable medium embodying instructions that, when executed by a processor perform operations comprising:
providing a request for an item to one or more providers, the item is one or more of a product and a service;
receiving one or more bids to provide an offer for the requested item;
comparing the received bids;
informing the one or more providers of the one or more most competitive bids; and
repeating the receive, compare, and inform operations until a bidding period ends.
